(19) United States
(12) Patent Application Publication
(10) Pub. No.: US 2016/0119527 A1
(43) Pub. Date: Apr. 28, 2016

(54) VEHICLE VISION SYSTEM CAMERA WITH DUAL FILTER

(71) Applicant: MAGNA ELECTRONICS INC., Auburn Hills, MI (US)

(72) Inventors: Umer Shahid, Rochester Hills, MI (US); Yuesheng Lu, Farmington Hills, MI (US)

(21) Appl. No.: 14/919,189

(22) Filed: Oct. 21, 2015

Related U.S. Application Data
(60) Provisional application No. 62/067,112, filed on Oct. 22, 2014.

(51) Int. Cl. H04N 5/235; H04N 5/33; H04N 5/232; H04N 5/225; G06T 5/20

(52) U.S. Cl. CPC H04N 5/2354; H04N 5/2258; G06T 5/20; H04N 5/23212; H04N 5/33; G06T 2207/10024

(57) ABSTRACT

A vision system for a vehicle includes a camera having a field of view exterior of the vehicle when disposed thereat. The camera includes a lens and an imager. A filter is disposed at one of the lens and the imager. The filter (i) substantially passes visible light within a first spectral band of light, (ii) substantially passes near infrared light within a second spectral band of light, and (iii) substantially attenuates light within at least a third spectral band of light. The third spectral band of light is between the first and second spectral bands of light and the filter may substantially attenuate light within a spectral band of light having wavelengths greater than the wavelengths of the second spectral band of light. An image processor is operable to process image data captured by the camera.

### CROSS REFERENCE TO RELATED APPLICATION

The present application claims the filing benefits of U.S. provisional application Ser. No. 62/067,112, filed Oct. 22, 2014, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

The present invention provides a vision system or imaging system for a vehicle that utilizes one or more cameras (preferably one or more CMOS cameras) to capture image data representative of images exterior of the vehicle, and provides the communication/data signals, including camera data or captured image data, that may be displayed at a display screen that is viewable by the driver of the vehicle, such as when the driver is backing up the vehicle, and that may be processed and, responsive to such image processing, the system may detect an object at or near the vehicle and in the path of travel of the vehicle, such as when the vehicle is backing up. The vision system may be operable to display a surround view or bird's eye view of the environment at or around or at least partially surrounding the subject or equipped vehicle, and the displayed image may include a displayed image representation of the subject vehicle. The vision system may be also operable to display objects such as animals and/or pedestrians far away in front of the vehicle for viewing by the driver to mitigate or avoid collision.

The vision system of the present invention includes a camera having a dual filter that functions to filter near infrared light at the imager while passing visible light and a selected range or spectral band of infrared light or near infrared light. Thus, the camera can capture color images during daytime lighting conditions and can also capture images in low lighting conditions, where an infrared light source (that emits light that is within the spectral band of light that is passed by the dual filter) may be used to enhance imaging in such low lighting conditions.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras in accordance with the present invention;

FIG. 2 is a graph showing the spectrum response curve of a typical CMOS imaging sensor;

FIG. 3 is another graph of the spectrum response curve of FIG. 2, showing the range of wavelengths that are attenuated by an IR cut-off filter;

FIG. 4 is a side view of a camera suitable for use in the vision system of the present invention; and

FIG. 5 is a graph showing the spectral bands passed and attenuated by the dual IR filter on the vehicle vision system camera of the present invention.

### DESCRIPTION OF THE PREFERRED EMBODIMENTS

A vehicle vision system and/or driver assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide a top down or bird's eye or surround view display and may provide a displayed image that is representative of the subject vehicle, and optionally with the displayed image being customized to at least partially correspond to the actual subject vehicle. Optionally, the vision system may have a camera that is mounted behind the windshield and facing forward and that may provide viewing of and detection of objects such as animals and/or pedestrians far away in front of the subject vehicle in the predicted driving path of the subject vehicle. Optionally, the vision system may provide images of objects inside the subject vehicle to view or detect the driver and/or passenger of the vehicle so as to track driver or passenger facial or hand gestures, or body or eye movement.

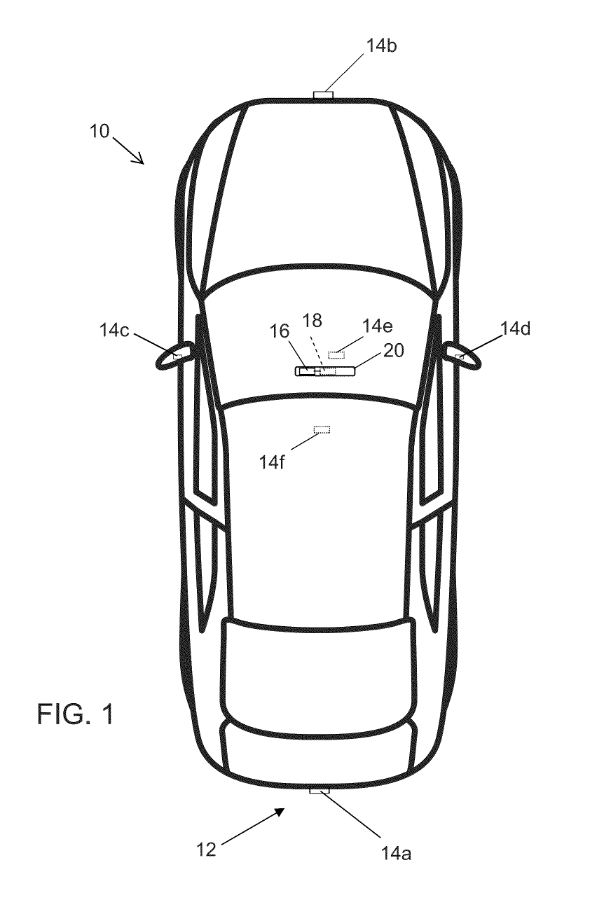

Referring now to the drawings and the illustrative embodiments depicted therein, a vehicle 10 includes an imaging system or vision system 12 that includes at least one exterior facing imaging sensor or camera, such as a rearward facing imaging sensor or camera 14a (and the system may optionally include multiple exterior facing imaging sensors or cameras, such as a forwardly facing camera 14b at the front (or a camera 14e at the windshield and viewing through the windshield) of the vehicle, and a sidewardly/rearwardly facing camera 14c, 14d at respective sides of the vehicle), which captures images exterior of the vehicle, or an inward facing camera 14f, with the camera or each of the cameras having a lens for focusing images at or onto an imaging array or imaging plane or imager of the camera (FIG. 1). The vision system 12 includes a control or electronic control unit (ECU) or processor 18 that is operable to process image data captured by the cameras and may provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a NTSC analog link, a LVDS digital link, an Ethernet digital link, a vehicle network bus or the like of the equipped vehicle.

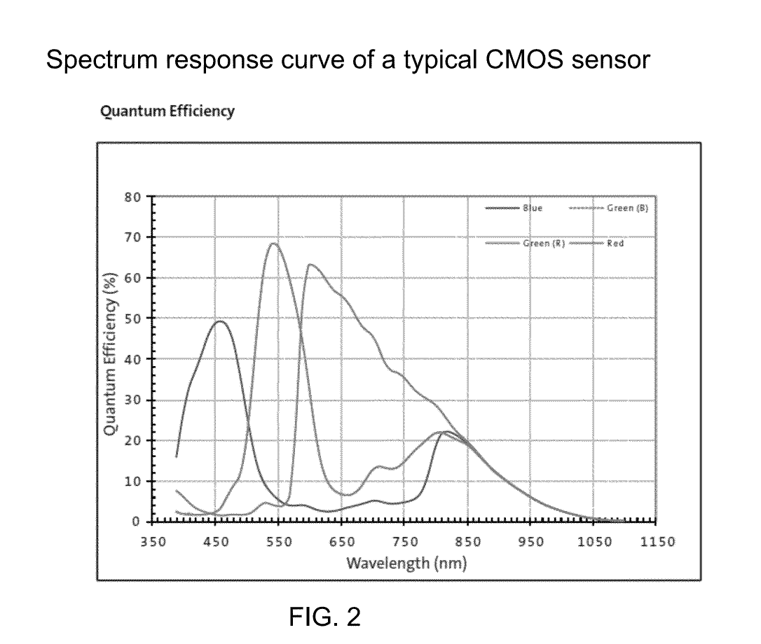

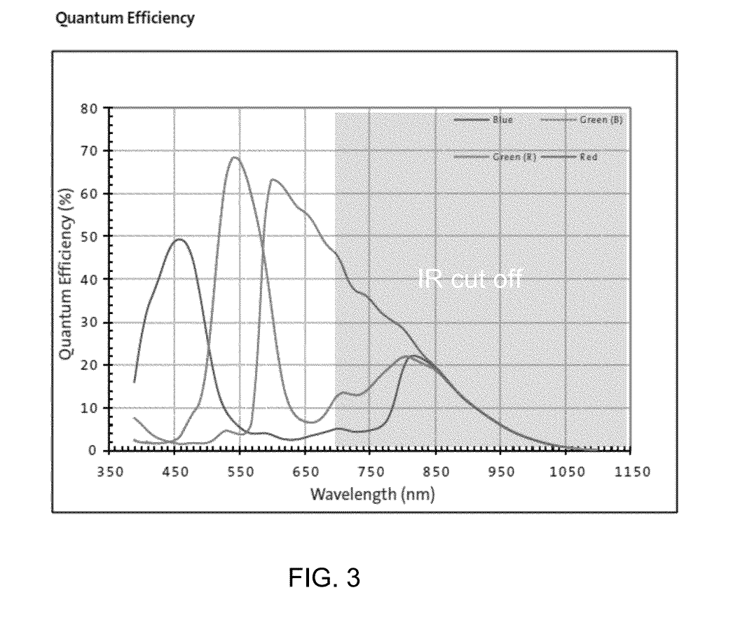

Typically, the cameras 14c, 14d mounted at a vehicle on the driver side and passenger side for a surround view system suffer in dark or low lighting conditions due to the absence of an illuminator or light source at either side of the vehicle. As shown in FIG. 2, Silicon-based imaging sensors (such as a CMOS imaging array comprising a plurality of photosensing elements established on a semiconductor substrate) are typically sensitive up to around 1125 nm wavelength (above the visible spectrum range). Human perception is limited to the visible spectrum ranging between wavelengths of about 380 nm and about 780 nm. The ambient light at the camera or imaged by the camera typically includes near infrared (NIR) light or signals, which cause color reproduction issues and reduce image contrast in captured images. In order to match human visual perception, the NIR part of the radiation incident on the cameras is usually blocked or filtered by an IR cut-off filter (FIG. 3).

At night time and in the absence of any light source in the visible spectrum, the image is really dark and it is very difficult to visualize objects, such as in the case of cameras mounted at the driver side and passenger side of a vehicle for a surround view system.

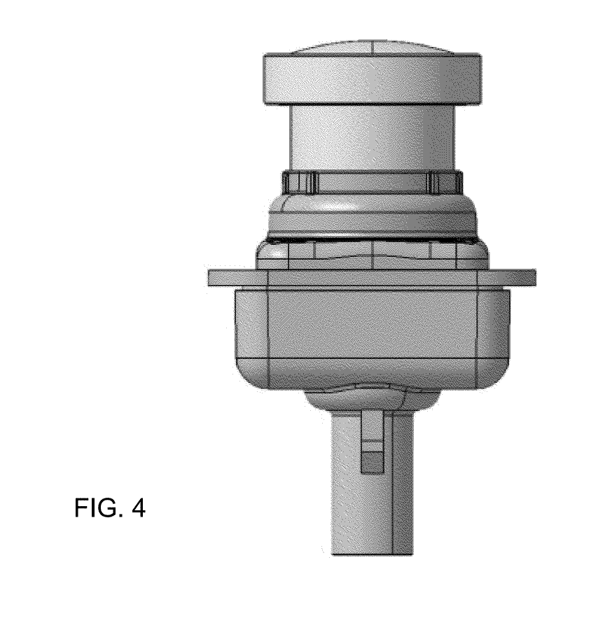

Thus, the present invention provides a camera (FIG. 4) for use as a side view camera in a surround view system, with the camera having a dual IR filter and with the field of view of the camera being at least partially illuminated by a near IR (NIR) illuminator or light source.

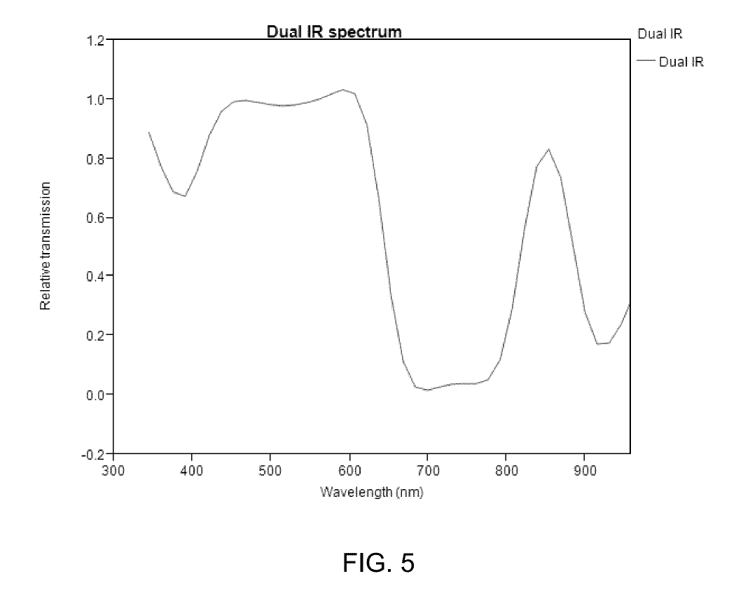

The dual IR filter passes visible wavelengths and a selected NIR range of wavelengths. For example, and such as shown in FIG. 5, the filter may substantially pass light having wavelengths between about 350 nm and about 650 nm (such as between about 450 nm and about 650 nm or such as less than about 650 nm), and may substantially pass light having wavelengths between about 830 nm and about 900 nm, while substantially blocking or attenuating other light (such as some near infrared light and infrared light). For example, the filter may substantially pass light within a first spectral band, such as light having a wavelength of between about 400 nm and about 600 nm (or between about 450 nm and about 650 nm), such as passing at least about 60 percent or such as passing at least about 70 percent or such as passing at least about 80 percent of light within that first spectral band. The filter may also substantially pass light within a second spectral band, such as light having a wavelength of between about 830 nm and about 880 nm, such as passing at least about 60 percent or such as passing at least about 70 percent or such as passing at least about 80 percent of light within that second spectral band. The filter also substantially attenuates other light within at least a third spectral band, such as light having a wavelength between the first and second spectral bands, such as light having a wavelength of between about 680 nm and about 800 nm, such as passing less than about 30 percent or such as passing less than about 20 percent or such as passing less than about 10 percent of light within that third spectral band. The filter may also substantially attenuate other light having a wavelength greater than that of the second spectral band (such as greater than about 900 nm), such as passing less than about 30 percent or such as passing less than about 20 percent or such as passing less than about 10 percent of light having a wavelength greater than the upper bound of the second spectral band.

Optionally, the vision system may use an illuminator or light source that emits light having a similar wavelength as the near infrared light (the second spectral band) passed by the filter (such as an illuminator that emits light having a wavelength between about 830 nm and about 900 nm) to provide enhanced vision at night or low lighting conditions. The illuminator or light source or infrared light emitting LED provides light that is visible to the camera only and is invisible to human eyes. In higher lighting conditions or daytime lighting conditions (where the illuminator is not activated), the camera images the visible light that is passed by the dual filter to provide enhanced color imaging during daytime.

Due to the narrow bandpass nature of the dual IR filter, the NIR light passing through the filter in daytime illumination is minimum and poses limited to no effect to the color reproduction of the imager. Furthermore, the imager register setting can be tuned in such a way that the daytime color reproduction performance of the camera is less affected by the pass-through NIR light. The wavelength spread of the LED (or laser) is narrow by nature, so the filter can be designed such that the NIR pass-band of the filter is narrow enough to let only the illumination light pass through and reduce pass through of light having other NIR wavelengths.

The illuminator may be activated responsive to a determination of the ambient light level at the vehicle (such as responsive to an ambient light level determined by processing image data captured by one or more of the vision system cameras), whereby the illuminator is activated when the ambient light level is below a threshold level and is not activated when the ambient light level is above a threshold level. The present invention thus provides a camera and vision system of a surround view system of a vehicle that has good color performance and good nighttime performance with the same camera.

The dual IR filter of the camera of the vision system of the present invention comprises any suitable filter that passes certain wavelengths or spectral bands of light, while blocking or attenuating other wavelengths or spectral bands of light. For example, the filter may comprise a coating or coatings (such as multiple layers of coatings at selected thicknesses and materials so that the combination of coatings results in the selected attenuation function) at a surface or surfaces of an optic of the camera lens or the cover glass of the imager (and the filter may utilize aspects of the coatings described in U.S. Pat. Nos. 7,626,749; 7,255,451; 7,274,501 and/or 7,184,190, which are hereby incorporated herein by reference in their entireties). Such a dual band IR coating on the lens or the cover glass of the imager passes or transmits the selected ranges of light to the imager, where the color imager images the visible light that is passed and focused by the lens. The coating may be applied to a lens of a camera that uses a known CMOS imager. The coatings are provided at the lens to provide the desired or selected range of wavelengths to pass through the lens to the imager, where the color imager (having its own color filters established thereat) can capture color images during daytime and night vision images during nighttime.

The NIR illumination will provide adequate illumination (in the near infrared and not visible range of the spectrum) for the imager without being seen by drivers and passengers at night. Because front camera can use the light from the vehicle's headlights during nighttime lighting conditions and the rear backup cameras can use light from the reverse or backup lights of the vehicle during nighttime lighting conditions, the dual IR filter and illuminator are highly suitable for use with side view cameras mounted at the sides of the vehicle (such as at the exterior rearview mirror assemblies of the vehicle), since there is typically no light source at the sides of the vehicle that is/are operable during forward or reverse travel of the vehicle.

Optionally, the NIR illuminator and dual IR filter may be used with a reverse or backup camera, where the NIR illuminator may operate to illuminate the area rearward of the vehicle along with the reverse or backup lights of the vehicle to improve night time visibility over long distances and to improve nighttime image quality of the captured images. Optionally, the camera of the present invention may be used as a rear backup camera or a forward facing camera, with or without use of the NIR illuminator. Optionally, the camera of the present invention may have use as a vehicle in-cabin camera or monitor or the like.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in International Publication Nos. WO 2013/081984 and/or WO 2013/081985, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an EyeQ2 or EyeQ3 image processing chip available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ladar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. Preferably, the imaging array has at least 300,000 photosensor elements or pixels, more preferably at least 500,000 photosensor elements or pixels and more preferably at least 1 million photosensor elements or pixels. The imaging array may capture color image data, such as via spectral filtering at the array, such as via an RGB (red, green and blue) filter or via a red/red complement filter or such as via an RCCC (red, clear, clear, clear) filter or the like, where the filter elements filter light at the individual photosensor elements. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, which are all hereby incorporated herein by reference in their entireties. The system may communicate with other communication systems via any suitable means, such as by utilizing aspects of the systems described in International Publication Nos. WO/2010/144900; WO 2013/043661 and/or WO 2013/081985, and/or U.S. Pat. No. 9,126,525, which are hereby incorporated herein by reference in their entireties.

The imaging device and control and image processor and any associated illumination source, if applicable, may comprise any suitable components, and may utilize aspects of the cameras and vision systems described in U.S. Pat. Nos. 5,550,677; 5,877,897; 6,498,620; 5,670,935; 5,796,094; 6,396,397; 6,806,452; 6,690,268; 7,005,974; 7,937,667; 7,123,168; 7,004,606; 6,946,978; 7,038,577; 6,353,392; 6,320,176; 6,313,454 and/or 6,824,281, and/or International Publication Nos. WO 2010/099416; WO 2011/028686 and/or WO 2013/016409, and/or U.S. Pat. Publication Nos. US 2010-0020170 and/or US-2013-0002873, which are all hereby incorporated herein by reference in their entireties. The camera or cameras may comprise any suitable cameras or imaging sensors or camera modules, and may utilize aspects of the cameras or sensors described in U.S. Publication No. US-2009-0244361 and/or U.S. Pat. Nos. 8,542,451; 7,965,336 and/or 7,480,149, which are hereby incorporated herein by reference in their entireties. The imaging array sensor may comprise any suitable sensor, and may utilize various imaging sensors or imaging array sensors or cameras or the like, such as a CMOS imaging array sensor, a CCD sensor or other sensors or the like, such as the types described in U.S. Pat. Nos. 5,550,677; 5,670,935; 5,760,962; 5,715,093; 5,877,897; 6,922,292; 6,757,109; 6,717,610; 6,590,719; 6,201,642; 6,498,620; 5,796,094; 6,097,023; 6,320,176; 6,559,435; 6,831,261; 6,806,452; 6,396,397; 6,822,563; 6,946,978; 7,339,149; 7,038,577; 7,004,606; 7,720,580 and/or 7,965,336, and/or International Publication Nos. WO/2009/036176 and/or WO/2009/046268, which are all hereby incorporated herein by reference in their entireties.

Optionally, the circuit board or chip may include circuitry for the imaging array sensor and or other electronic accessories or features, such as by utilizing compass-on-a-chip or EC driver-on-a-chip technology and aspects such as described in U.S. Pat. Nos. 7,255,451 and/or 7,480,149 and/or U.S. Publication No. US-2006-0061008, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vision system of a vehicle, said vision system comprising:
a camera configured to be disposed at a vehicle so as to have a field of view exterior of the vehicle;
wherein said camera comprises a lens and an imager;
wherein said imager comprises a pixelated imaging array having a plurality of photosensing elements;
wherein said camera comprises a filter disposed at one of said lens and said imager, wherein said filter (i) substantially passes visible light within a first spectral band of light, (ii) substantially passes near infrared light within a second spectral band of light, and (iii) substantially attenuates light within a third spectral band of light;
wherein said first spectral band of light comprises light having a wavelength of between about 450 nm and about 650 nm, and wherein said second spectral band of light comprises light having a wavelength of between about 820 nm and about 880 nm, and wherein said third spectral band of light comprises light having a wavelength between said first and second spectral bands of light;
an illumination source operable to illuminate an area encompassed by the field of view of said camera, wherein said illumination source is operable to emit light having a wavelength within said second spectral band of light;
wherein, during daytime lighting conditions, said camera captures color images without use of said illumination source;
wherein, during nighttime lighting conditions, said illumination source is activated and said camera captures images of the area illuminated by said illumination source; and
an image processor operable to process image data captured by said camera.

2. The vision system of claim 1, wherein said camera and said illumination source are disposed at a side of the vehicle, and wherein said camera has at least a sideward field of view at the side of the vehicle.

3. The vision system of claim 2, comprising a second side camera and a second illumination source disposed at another side of the vehicle, wherein said second side camera includes a second filter that (i) substantially passes visible light within said first spectral band of light, (ii) substantially passes near infrared light within said second spectral band of light, and (iii) substantially attenuates light within at least said third spectral band of light.

4. The vision system of claim 2, comprising a plurality of other cameras, wherein said other cameras are disposed at the vehicle so as to have respective fields of view forward, rearward or inward of the vehicle.

5. The vision system of claim 1, wherein said camera further comprises a pixelated filter array disposed at said imager that filters spectral bands of light at individual ones of said photosensing elements.

6. The vision system of claim 5, wherein said pixelated filter array comprises an RCCC filter array and wherein said RCCC filter array comprises red filter elements disposed at respective individual ones of said photosensing elements and clear filter elements disposed at respective individual ones of said photosensing elements.

7. The vision system of claim 5, wherein said pixelated filter array comprises an RGB filter array and wherein said RGB filter array comprises red filter elements disposed at respective individual ones of said photosensing elements and green filter elements disposed at respective individual ones of said photosensing elements and blue filter elements disposed at respective individual ones of said photosensing elements.

8. The vision system of claim 5, wherein said pixelated filter array comprises a red/red complement filter array and wherein said red/red complement filter array comprises red filter elements disposed at respective individual ones of said photosensing elements and red complement filter elements disposed at respective individual ones of said photosensing elements.

9. The vision system of claim 1, wherein said third spectral band of light comprises light having a wavelength between about 680 nm and about 800 nm.

10. The vision system of claim 1, wherein said filter substantially attenuates light having a wavelength of greater than about 900 nm.

11. The vision system of claim 1, wherein said filter (i) passes at least about 60 percent of visible light within said first spectral band of light, (ii) passes at least about 60 percent of near infrared light within said second spectral band of light, and (iii) passes less than about 30 percent of light within said third spectral band of light.

12. A vision system of a vehicle, said vision system comprising:
a camera configured to be disposed at a vehicle so as to have a field of view exterior of the vehicle;
wherein said camera comprises a lens and an imager;
wherein said imager comprises a pixelated imaging array having a plurality of photosensing elements;
wherein said camera comprises a pixelated filter array disposed at said imager that filters spectral bands of light at individual ones of said photosensing elements;
wherein said camera comprises a dual pass filter disposed at one of said lens and said imager, wherein said dual pass filter (i) passes at least about 60 percent of visible light within a first spectral band of light, (ii) passes at least about 60 percent of near infrared light within a second spectral band of light, and (iii) passes less than about 30 percent of light within a third spectral band of light;
wherein said first spectral band of light comprises light having a wavelength of between about 450 nm and about 650 nm, and wherein said second spectral band of light comprises light having a wavelength of between about 820 nm and about 880 nm, and wherein said third spectral band of light comprises light having a wavelength between said first and second spectral bands of light; and
an image processor operable to process image data captured by said camera.

13. The vision system of claim 12, comprising a second camera configured to be disposed at the vehicle so as to have a second field of view exterior of the vehicle, wherein said second camera includes a second dual pass filter that (i) passes at least about 60 percent of visible light within said first spectral band of light, (ii) passes at least about 60 percent of near infrared light within said second spectral band of light, and (iii) passes less than about 30 percent of light within said third spectral band of light.

14. The vision system of claim 12, wherein said pixelated filter array comprises a filter array selected from the group consisting of (i) an RCCC filter array and wherein said RCCC filter array comprises red filter elements disposed at respective individual ones of said photosensing elements and clear filter elements disposed at respective individual ones of said photosensing elements, (ii) an RGB filter array and wherein said RGB filter array comprises red filter elements disposed at respective individual ones of said photosensing elements and green filter elements disposed at respective individual ones of said photosensing elements and blue filter elements disposed at respective individual ones of said photosensing elements, and (iii) a red/red complement filter array and wherein said red/red complement filter array comprises red filter elements disposed at respective individual ones of said photosensing elements and red complement filter elements disposed at respective individual ones of said photosensing elements.

15. The vision system of claim 12, wherein said third spectral band of light comprises light having a wavelength between about 680 nm and about 800 nm.

16. The vision system of claim 12, wherein said filter substantially attenuates light having a wavelength of greater than about 900 nm.

17. A vision system of a vehicle, said vision system comprising:
a camera configured to be disposed at a vehicle so as to have a field of view exterior of the vehicle;
wherein said camera comprises a lens and an imager;
wherein said imager comprises a pixelated imaging array having a plurality of photosensing elements;
wherein said camera comprises a pixelated filter array disposed at said imager that filters spectral bands of light at individual ones of said photosensing elements;
wherein said camera comprises a dual pass filter disposed at one of said lens and said imager, wherein said dual pass filter (i) substantially passes visible light within a first spectral band of light, (ii) substantially passes near infrared light within a second spectral band of light, and (iii) substantially attenuates light within a third spectral band of light;
wherein said first spectral band of light comprises light having a wavelength of between about 450 nm and about 650 nm, and wherein said second spectral band of light comprises light having a wavelength of between about 820 nm and about 880 nm, and wherein said third spectral band of light comprises light having a wavelength between said first and second spectral bands of light;
wherein said dual pass filter substantially attenuates light having a wavelength greater than about 900 nm; and
an image processor operable to process image data captured by said camera.

18. The vision system of claim 17, comprising an illumination source operable to illuminate an area encompassed by the field of view of said camera, wherein said illumination source is operable to emit light having a wavelength within said second spectral band of light, and wherein, during daytime lighting conditions, said camera captures color images without use of said illumination source, and wherein, during nighttime lighting conditions, said illumination source is activated and said camera captures images of the area illuminated by said illumination source.

19. The vision system of claim 17, comprising a second side camera configured to be disposed at the vehicle so as to have a second field of view exterior of the vehicle, wherein said second camera includes a second dual pass filter that (i) substantially passes visible light within said first spectral band of light, (ii) substantially passes near infrared light within said second spectral band of light, (iii) substantially attenuates light within said third spectral band of light, and (iv) substantially attenuates light having a wavelength greater than about 900 nm.

20. The vision system of claim 17, wherein said dual pass filter (i) passes at least about 60 percent of visible light within said first spectral band of light, (ii) passes at least about 60 percent of near infrared light within said second spectral band of light, (iii) passes less than about 30 percent of light within said third spectral band of light, and (iv) passes less than about 30 percent of light having a wavelength greater than about 900 nm.
